(19) United States
(12) Patent Application Publication
(10) Pub. No.: US 2002/0116713 A1
(43) Pub. Date: Aug. 22, 2002

(54) Television receiver and method

(76) Inventors: Haruo Mukai, Tokyo (JP); Teruo Tobe, Tokyo (JP); Hitoshi Ohura, Tokyo (JP); Tatsuhiko Sakamoto, Tokyo (JP); Tomoyuki Ishii, Kawasaki (JP)

Correspondence Address: Rosenman & Colin LLP, 575 Madison Avenue, New York, NY, 10022-2585, US

(21) Appl. No.: 10/115,818

(22) Filed: Apr. 2, 2002

Related U.S. Application Data
(63) Continuation of application No. PCT/JP99/05859, filed on Oct. 22, 1999.

(51) Int. Cl. G06F 3/00

(52) U.S. Cl. 725/58

(57) ABSTRACT

The present invention aims at providing a TV receiver capable of relieving a burden to search for a TV program desired by a user and enabling the user to surely watch the TV program at a necessary time in a TV broadcast consisting a multiplicity of channels. The television receiver of the present invention comprises a receiving unit for receiving a television broadcast by selecting a specified broadcast channel from a plurality of broadcast channels, a control unit for controlling said receiving unit in order to receive the television broadcast of the specified broadcast channel, a means for receiving virtual channel information containing information for specifying a time zone and information related to the broadcast channel that should be selected in this time zone, a means for storing the virtual channel information, and a timer for notifying said control unit of a time.

This is a continuation of Application PCT/JP 99/05859, filed on Oct. 22, 1999, now abandoned.

### BACKGROUND OF THE INVENTION

The present invention relates generally to a technology of receiving a television broadcast, and more particularly to a television receiver suitable for receiving multi-channel TV broadcasts such as CATV, satellite broadcasts or ground wave digital broadcasts, and automatically selecting the channel by reserving a program.

The TV broadcasts have a multiplicity and multi-categories of broadcast channels (100 or more channels)due to spreads of the CATV and the satellite broadcasting. As a result, the situation is that it is difficult for the user to grasp which channel a TV program the user initially wants to watch is broadcast at and to select this broadcast channel at a proper time. A video record reserving system as disclosed in Japanese Patent Application Laying-Open Publication No. 7-184131 is known as a system for relieving a labor for receiving this type of TV broadcast. This system is that a program list is created from program information transmitted together with TV signals and displayed on a screen of the TV receiver. The user is thereby able to reserve recording the program by selecting this program on the screen.

Further, there is also spread a method of reserving the record by utilizing a TV program list opened to the public on a Web page in the Internet. Namely, the TV program list is displayed on the screen of a personal computer, and the user can reserve recording the program by selecting this program on the screen.

This type of record reserving system is, though capable reducing the labor to input a channel that should be recorded, a start time, an end time and others, a system in which the program list is displayed on the screen, and the user manually selects the program that should be recorded from this list in any case.

According to this manual selection type described above, in the case of watching the multi-channel TV broadcasts such as the CATV and the satellite broadcasts, the user must search for and select the desired program from a tremendous amount of program lists. Accordingly, the user's labor and burden for selecting the program are not essentially relieved.

### SUMMARY OF THE INVENTION

It is an object of the present invention, which was devised in view of the problems inherent in the prior arts described above, to provide a television receiver capable of relieving a user's burden to search for a TV program and enabling the user to surely watch the TV program at a necessary time in a TV broadcast consisting a multiplicity of channels.

Namely, the present invention aims at providing a technology of receiving the TV broadcast without a user's labor to search for the program and to switch over the channel, and a technology of distributing information related to this program.

To accomplish the above objects, the present invention adopts the following means. Namely, according to one aspect of the present invention, a television receiver comprises a receiving unit for receiving a television broadcast by selecting a specified broadcast channel from a plurality of broadcast channels, a control unit for controlling the receiving unit in order to receive the television broadcast of the specified broadcast channel, channel information unit for receiving virtual channel information containing information for specifying a time zone and information related to the broadcast channel that should be selected in this time zone, storing unit for storing the virtual channel information, and a timer for notifying the control unit of a time.

Herein, the broadcast channel is a channel, a so-called TV channel at which an actual TV broadcast is broadcast. This actual broadcast channel is also called a physical channel. Further, the virtual channel information contains information, e.g., a channel number, related to the broadcast channel that should be received in each time zone. The control unit is notified of a time from the timer and therefore controls the receiving unit to switch over the broadcast channel that should be received in every predetermined time zone in accordance with the virtual channel information.

A specified number is allocated to the virtual channel specified by the virtual channel information described above. If the virtual channel number is specified, a receipt of the virtual channel is conceived to be specified, and the broadcast channel received in every time zone is switched over in accordance with the virtual channel information. Then, if a number other than the virtual channel number is specified, the broadcast may be received in a way that fixes it to the broadcast channel of this number.

This television receiver may further comprise editor unit for editing the virtual channel information. Herein, the edit involves adding, deleting or changing the-related-to-the-broadcast-channel information contained in the virtual channel information, which should be received in the predetermined time zone, or newly creating the virtual channel information.

According to another aspect of the present invention, a television receiver comprises display unit for displaying at least one virtual channel together with a plurality of broadcast channels to a user, and a virtual channel control unit for making the user receive a program reserved by the user among the plurality of broadcast channels when the virtual channel is specified. The virtual channels are displayed together with the broadcast channels, whereby the user can recognize that the virtual channels are selectable. When the user specifies the virtual channel, the program reserved by the user among the plurality of broadcast channels is received and can be watched through the virtual channel.

According to another aspect of the present invention, a television program distribution system for distributing programs through a plurality of broadcast channels, comprises selecting unit for selecting a recommended program recommended to receive, generating unit for generating virtual channel information containing a time zone of broadcasting this recommended program and a broadcast channel for broadcasting this recommended program, providing unit for the virtual channel information to a watching terminal, and switching unit for automatically switching over the broadcast channel received by the watching terminal on the basis of the virtual cannel information.

According to a further aspect of the present invention, a virtual channel information creating method of creating virtual channel information as a virtual channel into which a plurality of broadcast channels are combined, comprises a step of collecting program information containing at least information for specifying a time zone and information related to a program broadcast in this time zone with respect to the plurality of broadcast channels, a step of selecting a specified recommended program from the collected pieces of program information, and a step of generating virtual channel information containing information for specifying a time zone in which the recommended program is broadcast and information related to the broadcast channel that should be selected in this time zone.

All the programs broadcast at the specified broadcast channel may be selected as the recommended programs.

The recommended program may be selected based on a category as a type of the program.

The recommended program may be selected based on whether supplementary information exists in the collected program information or whether the contents (e.g. a structure and the number of data items, or the quantity of the data (This is similarly applied to the followings)) of the collected program information are changed. Herein, the supplementary information is the data describing explanation information of programs, an outline of program, names of casts, and profiles of cats and so on.

The recommended program may be selected based on a length of a broadcasting time.

The virtual channel information creating method may further comprise a step of collecting watching requests of viewers or watched history thereof, and the recommended program may be selected based on the watching requests or the watched history.

The virtual channel information creating method may further comprise a step of specifying a preferential program that should be preferentially selected as a recommended program, and the recommended programs may be selected in a way that gives the priority to this preferential program.

According to a still further aspect of the present invention, a virtual channel information creating system for creating virtual channel information as a virtual channel into which a plurality of broadcast channels are combined, comprises a program information collecting module for collecting program information containing at least information for specifying a time zone and information related to a program broadcast in this time zone with respect to the plurality of broadcast channels, a recommended program selection module for selecting a specified recommended program from the collected pieces of program information, and a virtual channel information generating module for generating virtual channel information containing information for specifying a time zone in which the recommended program is broadcast and information related to the broadcast channel that should be selected in this time zone.

According to a yet further aspect of the present invention, there is provided a readable-by-computer recording medium recorded with a virtual channel information creating program for creating virtual channel information as a virtual channel into which a plurality of broadcast channels are combined, the program comprising a step of collecting program information containing at least information for specifying a time zone and information related to a program broadcast in this time zone with respect to the plurality of broadcast channels, a step of selecting a specified recommended program from the collected pieces of program information, and a step of generating virtual channel information containing information for specifying a time zone in which the recommended program is broadcast and information related to the broadcast channel that should be selected in this time zone. Herein, the readable-by-computer recording medium are recording mediums capable of storing information such as data, programs, etc. electrically, magnetically, optically and mechanically or by chemical action, which can be read by the computer.

According to a still further aspect of the present invention, there is provided a readable-by-computer recording medium recorded with a control program for making a computer which is connected to a receiving unit for receiving a television broadcast by selecting a specified broadcast channel from a plurality of broadcast channels and channel information unit for receiving virtual channel information containing information for specifying a time zone and information related to the broadcast channel that should be selected in this time zone, function as: a control unit for controlling the receiving unit in order to receive the television broadcast of the specified broadcast channel; storing unit for storing the virtual channel information; and a timer for notifying the control unit of a time. This control unit is notified of a time from the timer and therefore controls the receiving unit to switch over the broadcast channel that should be received in every predetermined time zone in accordance with the virtual channel information.

According to a still further aspect of the present invention, the virtual channel information containing the information for specifying the time zone and the information related to the broadcast channel that should be selected in this time zone, is stored, and the receiving unit is controlled by switching over the broadcast channel that should be received in every predetermined time zone, thereby making it possible to provide the TV receiver capable of relieving the user's burden for searching for the TV program desired by the user and enabling the user to surely watch the TV program in a necessary time.

Further, the specified number is allocated to this virtual channel, and hence the user can utilize a function of the virtual channel by the same operation as that of the normal physical broadcast channel.

Namely, according to the present invention, there is relieved the user's labor to search for the program and switch over the channel when receiving the TV program.

### BRIEF DESCRIPTION OF THE DRAWINGS

FIG. 1 is a diagram showing an environment for receiving a TV broadcast by a TV receiver in an embodiment 1 of the present invention;

FIG. 2 is a block diagram showing an architecture of the TV receiver in the embodiment 1 of the present invention;

FIG. 3 is a block diagram showing an architecture of an edit device for editing virtual channel information at a center;

FIG. 4 is a diagram showing a concept of a virtual channel;

FIG. 5 is a diagram showing a data structure of the virtual channel information for expressing the virtual channel;

FIG. 6 is a diagram showing an example of editing the virtual channel information;

FIG. 7 is a diagram showing a relationship between a user and a virtual channel information provider in the TV broadcast;

FIG. 8 is a flowchart showing a procedure of creating the virtual channel information for specifying the virtual channel;

FIG. 9 is a diagram showing a procedure of switching over a broadcast channel;

FIG. 10 is a diagram showing a procedure of switching over the broadcast channel (physical channel);

FIG. 11 is a diagram showing a procedure of switching over the broadcast channel (virtual channel);

FIG. 12 is a diagram showing a modified example of a virtual channel information creating method;

FIG. 13 is a diagram showing a modified example of the virtual channel information creating method;

FIG. 14 is a diagram showing a modified example of the virtual channel information creating method;

FIG. 15 is a block diagram showing a broadcast system for providing the virtual channel in an embodiment 2 of the present invention; and

FIG. 16 is a flowchart showing a procedure of providing the virtual channel in the embodiment 2 of the present invention.

### DETAILED DESCRIPTION OF THE PREFERRED EMBODIMENT

Preferred embodiments of the present invention will hereinafter be explained with reference to the drawings.

### Embodiment 1

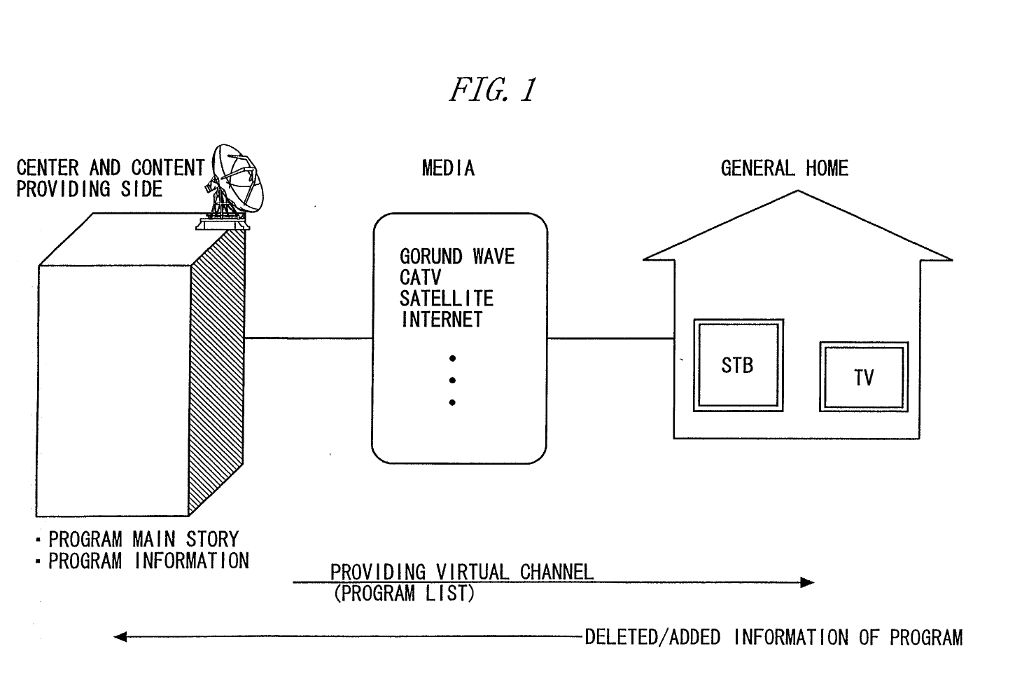

A television (TV) receiver in an embodiment 1 will be described in conjunction with the drawings in FIGS. 1 through 13.

<Architecture>

FIG. 1 illustrates an environment in which the TV receiver in the present embodiment receives a TV broadcast. A program of the TV broadcast is distributed to each of users in general homes via on ground waves, satellite broadcasting, a CATV network or Internet etc from a broadcast station or a CATV company (that will hereinafter be called a center). As shown in FIG. 1, the TV receiver in this embodiment enables a program to be watched by automatically switching a channel in accordance with programs and virtual channel information as a program list which are provided from the center. Note that a program main story shown in FIG. 1 is a content itself of the program, and program information is supplementary information such as a program schedule, captions on the programs and other.

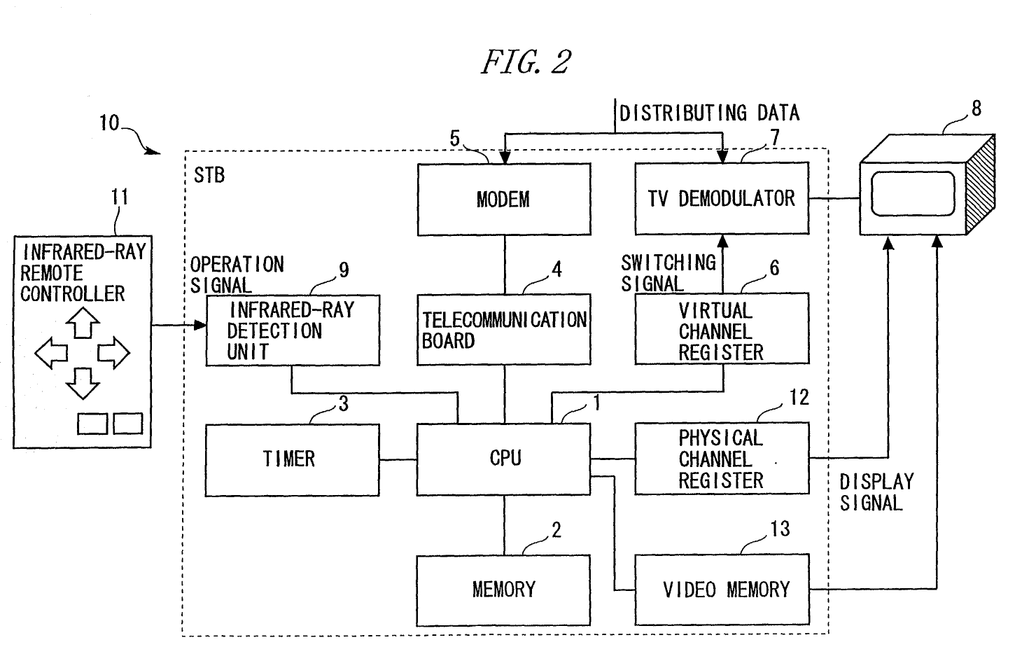

FIG. 2 is a block diagram showing an architecture of the TV received in this embodiment. As illustrated in FIG. 2, this TV receiver includes an STB 10 (set-top box) for receiving the program by selecting a specified broadcast channel among a plurality of broadcast channels, a TV monitor 8 for displaying a picture received and generating sounds, and an infrared-ray remote controller 11 (corresponding to a number specifying unit specifying the broadcast channel with a number) for transmitting an operation signal to the STB 10.

The STB 10 internally has a TV demodulator 7 (corresponding to a receiving unit) for demodulating the TV broadcast of the broadcast channel specified by the channel number, a virtual channel register 6 for indicating the channel number of the received broadcast channel to this TV demodulator 7, a physical channel register 12 for clearly showing a physical channel as the broadcast channel specified at the present, a CPU 1 for setting the channel number of the received broadcast channel in the virtual channel register 6 and controlling the whole STB 10, a memory 2 (corresponding to a storing unit storing virtual channel information) for storing a program executed by the CPU 1 and data, a video memory 13 for storing the data displayed by the CPU 1 on a screen of the TV monitor 8, a timer 3 for informing the CPU 1 of time, an infrared-ray detection unit 9 for receiving a switching signal with respect to the CPU 1, a modem 5 for transferring and receiving the data to and from the center, and a telecommunication board 4. The modem 5 and the telecommunication board 4 correspond to a channel information unit for receiving the virtual channel information.

The CPU 1 controls the respective components of the STB 10 by executing a control program stored in the memory 2. Namely, the CPU 1 displays selectable channel numbers and a menu screen on the TV monitor 8 in accordance with operation signals from the infrared-ray remote controller 11 that are detected by the infrared-ray detection unit 9. Further, with the user's operation about the channel number and menu displayed, there are provided functions such as auto-switching of the broadcast channel as a result of selecting the broadcast channel and selecting the virtual channel. The CPU 1 and the control program correspond to a control unit.

The infrared-ray remote controller (that will hereinafter be abbreviated to infrared-ray RC) 11 is used for selecting the broadcast channels (the physical channel and the virtual channel that will hereinafter be explained later on). Further, the infrared-ray RC 11 is used when adding, deleting, changing or newly creating the virtual channel information (these operations are termed an edit) as recommended programs distributed from the center in accordance with a user's idea on the user side. That is, the infrared-ray RC 11 is used for editing the virtual channel information by selecting desired items from the menu, buttons and a list of the broadcast channels displayed on the screen of the TV monitor 8 through the CPU 1 (CPU 1, the TV monitor the infrared-ray RC 11 corresponds also to an editor unit).

The physical channel register 12 retains the channel number of the broadcast channel selected by the infrared-ray RC 11, and indicates this channel number to the TV monitor 8. The TV monitor 8 displays the broadcast channel number indicated by the physical channel register 12 (which corresponds to a display unit displaying at least one virtual channel together with the plurality of broadcast channels).

The virtual channel register 6 retains the channel number that should be demodulated by the setting from the CPU 1, and indicates this to the TV demodulator 7. The broadcast channel to be received is changed by changing the setting of this virtual channel register 6.

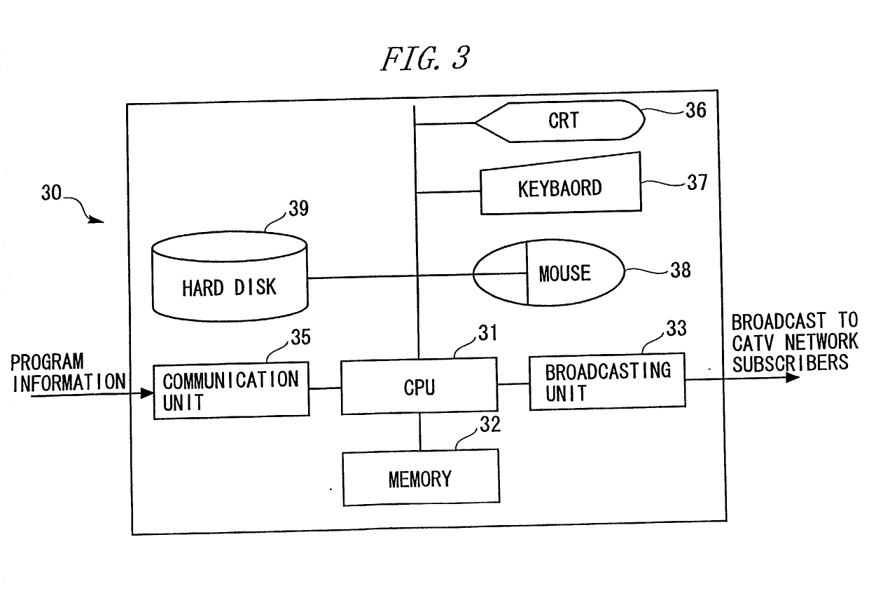

FIG. 3 is a block diagram illustrating a virtual channel information creating device 30 for creating the virtual channel at the center. This virtual channel information creating device 30 includes a CPU 31 for controlling the whole virtual channel information creating device 30 by executing the control program, a memory 32 for storing the control program and the data, a communication unit for receiving program information as a basis of the virtual channel information from a program provider, a broadcasting unit 33 for broadcasting (distributing) the generated virtual channel information to network subscribers, a hard disk 39 for recording the received program information and the generated virtual channel information, a keyboard 37 and a mouse 38 for inputting pieces of information, e.g., a preferential program and a specified category that should be inputted at the center when generating the virtual channel information, and a CRT 36 for displaying the generated virtual channel information and others.

The communication unit 35 among those receives the program information on every broadcast channel via a communication line. Further, the communication unit 35 receives responses, e.g., a watched history, watching requests (requests) and so on.

On the other hand, the CPU 31 executes the control program, and controls the receipts of the above program information, watched history and watching requests. Further the CPU 31 selects a recommended program and generates the virtual channel information. The communication unit 35 and the CPU 31 correspond to a program information collecting module, and the CPU 31 and the control program thereof correspond to a recommended program selection module and a virtual channel information generation module.

<Architecture of Virtual Channel>

In the TV receiver in this embodiment, the CPU 1 switches over the channel number of the virtual channel register 6 on the basis of the virtual channel information as the program list retained in the memory 2. As a result, the broadcast channel demodulated by the demodulator 7 is changed over in every time zone, thereby actualizing the virtual channels.

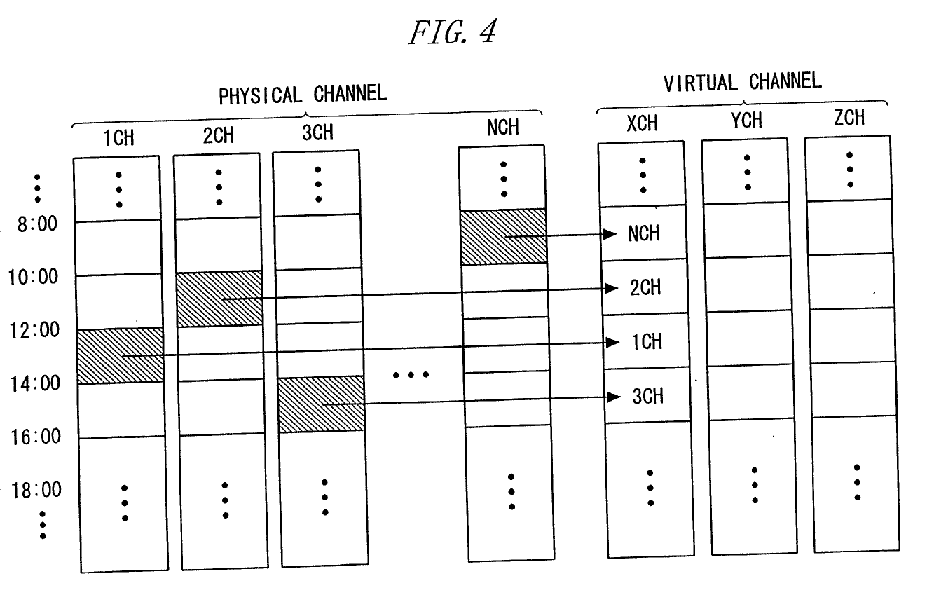

A concept of the virtual channel will be explained referring to FIG. 4. The broadcast channels that are actually broadcast from the center are indicated by 1ch, 2ch etc in FIG. 4. These channels are called physical channels.

On the other hand, Xch, Ych etc represent virtual channels actualized in this embodiment. For example, the virtual channel Xch corresponds to a virtual channel that receives a program at a physical channel Nch in a time zone of 8:00 through 10:00, receives a program at a physical channel 2ch in a time zone of 10:00 through 12:00, receives a program at a physical channel 1ch in a time zone of 12:00 through 14:00, and receives a program at a physical channel 3ch in a time zone of 14:00 through 16:00.

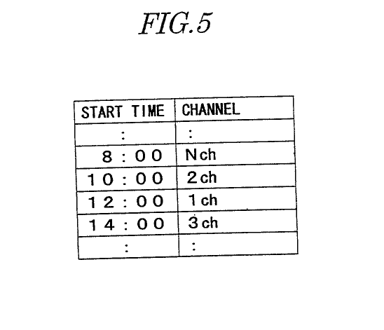

The information structured of a combination of those time zones and the physical channels that should be switched over in ever time zone, is expressed by a data structure shown in FIG. 5. This data structure is called a virtual channel table, and the information retained in this data structure is called virtual channel information. The virtual channel information is distributed from the center via the same media as that of the broadcast channel, then transmitted to the CPU 1 via the modem 5 and the telecommunication board 4, and stored in the memory 2.

In the present embodiment, the virtual channels are allocated to the channels with the channel numbers of 100 or larger. As shown in FIG. 2, in this embodiment, the physical channel register 12 for retaining he broadcast channel number (which will hereinafter be referred to as a physical channel number) selected by the user, is connected in a way of being capable of inputting and outputting from the CPU 1. The CPU 1 stores the physical channel register 12 with the physical channel number set by the user operating the infrared-ray RC 11. The physical channel number stored in this physical channel register 12 is displayed as the broadcast channel selected by the user at the present on the TV monitor 8, and is referred to from the CPU 1.

The CPU 1, if the physical channel number is equal to or larger than 100, reads the virtual channel information stored in the memory 2, and switches over the virtual channel register 6 corresponding to the time zone in accordance with a notification from the timer. The TV demodulator 7 switches over and demodulates the broadcast channel in accordance with an indication of the virtual channel register 6, and transmits demodulated signals to the TV monitor 8. Programs of the virtual channel into which the programs of the plurality of broadcast channels are combined by dividing the time, are thereby displayed on the TV monitor 8.

Note that if the physical channel number is smaller than 100, the physical channel number is set as it is in the virtual channel register, and a program of the broadcast channel having this physical channel number is demodulated and displayed on the TV monitor 8.

<Process in Distributing Virtual Channel Information>

Next, a method of creating and distributing the virtual channel information distributed from the center, will be explained. As described above, the virtual channel information contains the time zone as shown in FIG. 5 and the information indicating the broadcast channel that should be received in this time zone. The virtual channel information is created at the center based on the watched history of the user in the past, the watching requests (requests) of the programs or the recommendation information etc given from the broadcast company of each broadcast channel, then changed by the user after being temporarily distributed to the user, and thus finally determined.

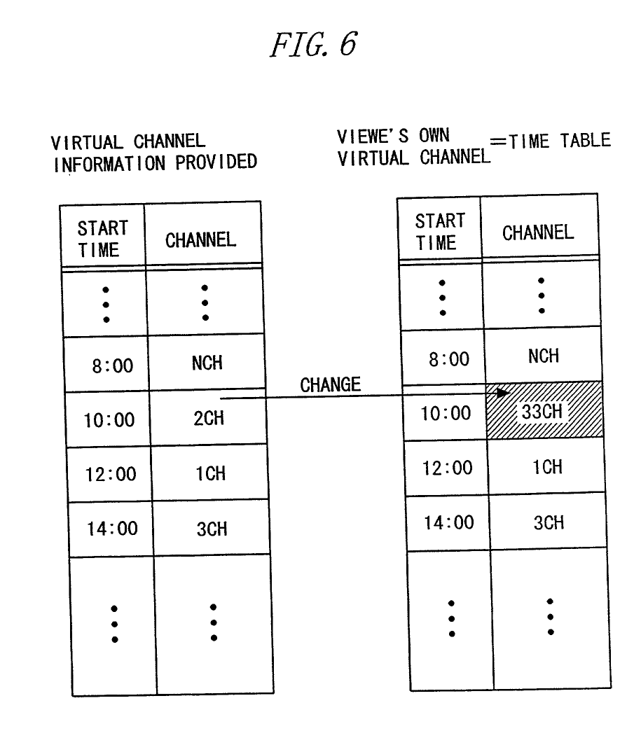

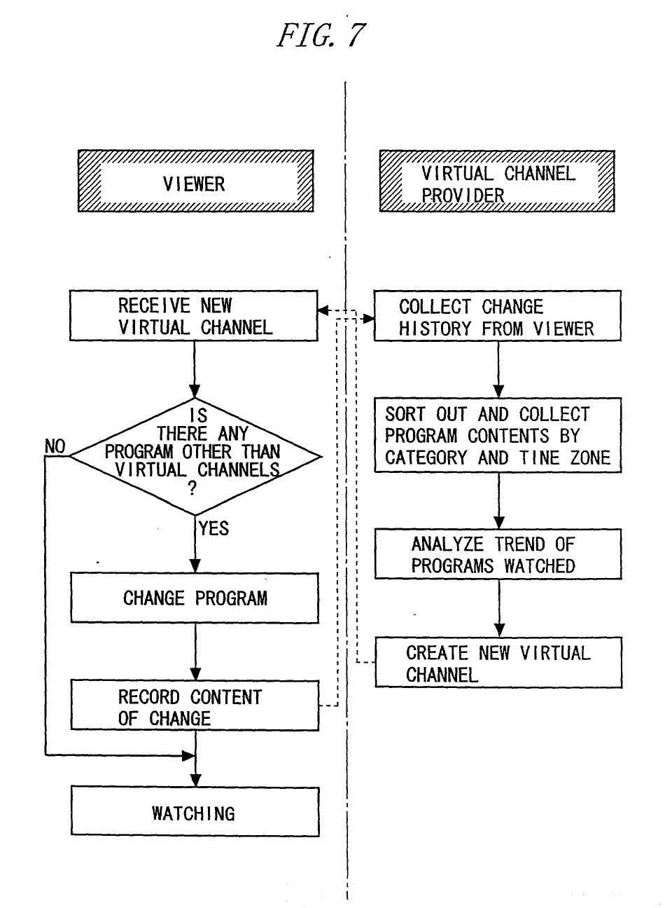

This relationship is shown in FIGS. 6 and 7. FIG. 6 shows an example of the virtual channel information provider from the center and the user's own virtual channel information rewritten and thus created by the user.

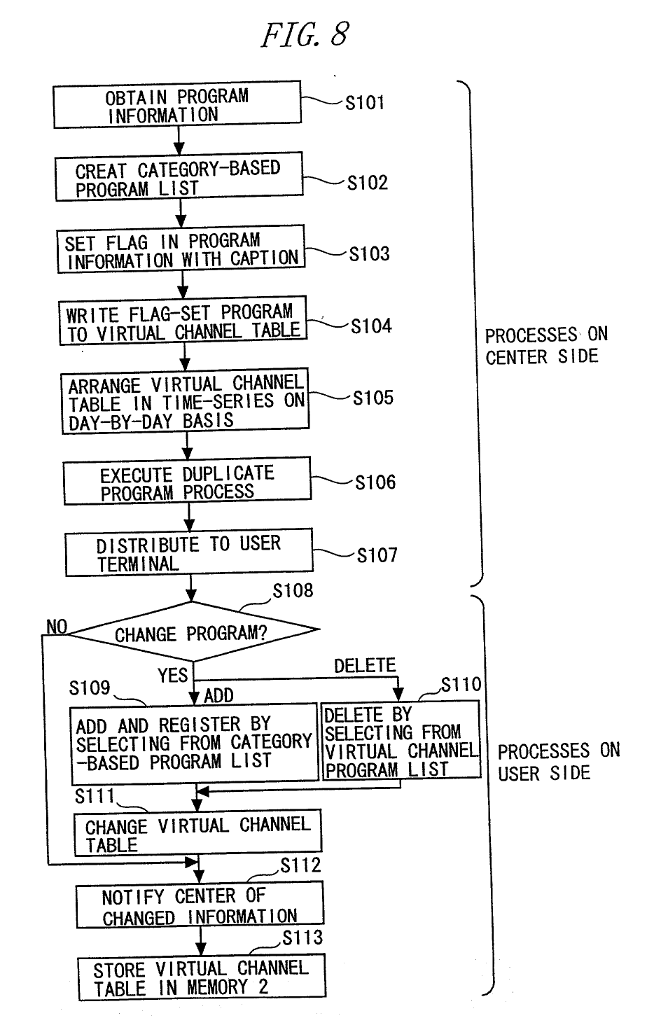

A relationship of transferring and receiving the information between the center and the user is illustrated in FIG. 7. To start with, the virtual channel provider (center) provides the virtual channel information to the user. Next, the user creates the user's own virtual channel information by changing the virtual channel information, and sends a content of this change back to the virtual channel provider (center). Through this process, change history is collected, a watching trend of the programs is grasped, and new pieces of virtual channel information are created by the virtual channel provider (center) Procedures of creating and distributing the virtual channel information to the respective users are shown in a flowchart in FIG. 8. As shown in FIG. 8, the procedures of creating the virtual channel information consist of two portions such as processes on the center side and processes on the user side. Of these two portions, the processes on the center side are executed as a control program in the CPU 31 of the virtual channel information creating device 30 shown in FIG. 3. Further, the processes on the user side are executed as a control program in the CPU 1 of the TV receiver 10 shown in FIG. 2.

In the processes on the center side in this embodiment, what the caption information is supplemented to the program information is selected as a recommended program. The caption information is data for a program producer or a program provider to explain the user about a brief and a highlight of the program. The caption information can be conceived as what the program producer or the program provider supplement the program with they particularly wish the user to watch. Further, it can be considered that a data size (character count) becomes larger as the program producer of the program provider gets keener about providing the program. The caption information corresponds to supplementary information. The supplementary information, however, contains, in addition to the caption information, pieces of information about a brief, names and profiles of figures appeared, an original author, a producer etc.

The explanation will hereinafter be given based on the flowchart in FIG. 8.

At first, the center obtains the program information of the physical channels from the broadcast companies of the respective physical channels (step 101, which will hereinafter be abbreviated to S101).

Next, there is created a category-based list of the programs in which the programs of the respective physical channels are classified according to categories (S102).

Next, a flag is set in the program information of the program as a recommended program supplemented with the caption information created by the broadcast company of the physical channel among the respective programs having the program information obtained in S101 (S103).

Next, the program with the flag set herein is preferentially written to the table (virtual channel table) shown in FIG. 5 (S104).

Next, the virtual channel information from the virtual channel table is divided on a day-by-day basis and thus arranged in time-series (S105).

Next, a program overlap in the same time zone is removed (S106). Namely, if two or more programs are overlapped in the same time zone, the programs are selected so that one single program is set in each time zone. This is done in a way that gives the priority to what has a larger data size of the caption information. If the data sizes of the caption information of the programs overlapped with each other are the same, the priority is given to what has the lower physical channel number.

Further, with respect to the partially overlapped programs, the priority is given to the program that is anterior in time zone. Namely, after the program broadcast ahead has been completely finished, the channel is switched over to the next.

In this state, the virtual channel information and the category-based list of programs are distributed to the users (S107). If the user does not need to change the program to be watched, the center is informed of this purport (S112), and the virtual channel data distributed are stored as they are in the memory 2 (S113).

While on the other hand, if the user changes the program of the virtual channel information distributed, programs are selected from the program list created in S102 and added (S109), or the programs contained in the virtual channels are deleted (S110), changed or newly created, thus changing the content of the virtual channel table (S111) . Moreover, the center is informed of the changed information (S112), and the changed information is recorded as user's audience rating data in the center. Further, the changed virtual channel information is stored in the memory 2 (S113).

As described above, the program supplemented with the caption is preferentially incorporated into the programs of the virtual channel information, and hence the user is able to watch the programs especially recommended by the respective broadcast stations. Further, on this occasion, there does not occur a burden on the user to search out the recommended programs from the multiplicity of broadcast channels.

Moreover, the user is able to edit the virtual channel information such as adding, deleting and so on, and therefore the virtual channel particularized for every user can be created. This change may be done only about the programs not desired for watching among the recommended programs of the respective broadcasting stations, and is therefore less time-consuming than in the case of assembling individually pieces of virtual channel information in all the time zones.

<Program Receiving Process Based on Virtual Channel>

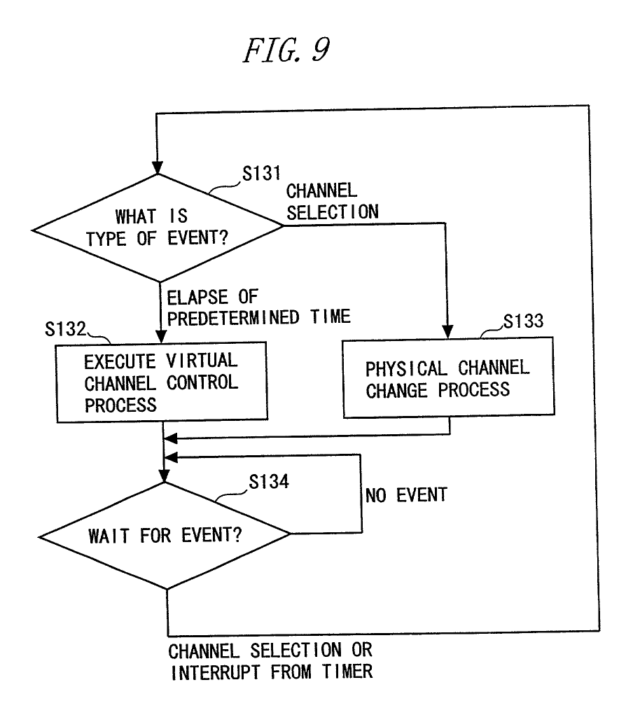

A receiving process based on the virtual channel information will be explained referring to FIGS. 9 through 11. As described above, in the TV receiver in this embodiment, the physical channels with their numbers of 100 or larger are treated as the virtual channels, and the physical channels with their numbers of less than 100 are treated intact as the broadcast channels.

The control program executed by the CPU 1 is normally in a wait-for-event status (S134). This event implies that the physical channel is changed by the user or that an interrupt from the timer occurs after an elapse of a predetermined time.

Namely, the event occurs just when the user changes the physical channel number by use of the infrared-ray RC 11 or when it comes to such a timing that the channel should be switched over accordance with the virtual channel information, and the control program is released from the wait status. To begin with, the control program confirms a type of the event (S131). If the event is the change of the physical channel, the operation enters a physical channel change process (S133). On the other hand, if the event is the elapse of the predetermined time, the operation enters a virtual channel control process in order to switch over the channel in accordance with the virtual channel information (S132).

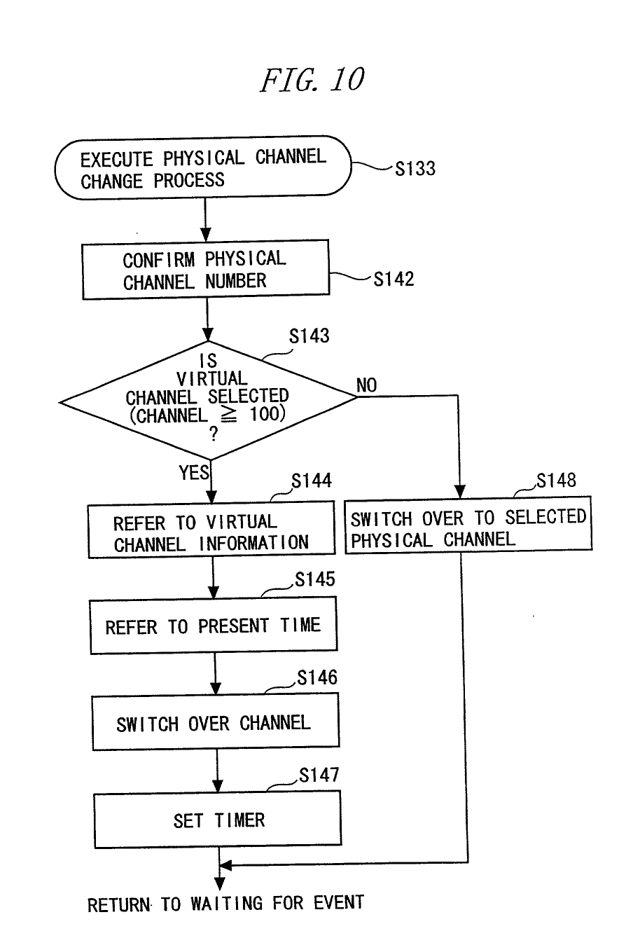

The physical channel change process will be explained referring to FIG. 10. At first, the control program confirms the changed physical channel number through an infrared-ray sensor 9 (S142).

If the selected physical channel number is less than 100, the virtual channel function is not used (S143), and hence the selected physical channel number is written to both of the physical channel register 12 and the virtual channel register 6. A content in this physical channel register 12 is displayed on the TV monitor 8 and is referred to by the CPU 1 itself. On the other hand, a content in the virtual channel register is directly transmitted to the TV demodulator 7, and a program of the physical channel (broadcast channel) indicated by this number is demodulated and projected on the TV monitor 8. Namely, the physical channel is thereby changed in the normal procedures (S148).

While on the other hand, if the selected physical channel number is 100 or larger (S143), the virtual channel function is used. The following processes are executed. At first, the virtual channel information is referred to (S144) . Further, the present time is referred to from an unillustrated calendar of OS executed by the CPU 1 (S145).

Next, based on the virtual channel information, the channel number of the physical channel that should be watched in the time zone containing the present time is set in the virtual channel register 6. The program of the physical channel (broadcast channel) specified by the virtual channel information is thereby demodulated and projected on the TV monitor 8 (S146).

Moreover, the timer 3 is set so as to interrupt when it is a predetermined time (S147), and there comes the wait-for-event status. Thereafter, whenever it comes to the predetermined time, the set value in the virtual channel register, i.e., the broadcast channel to be received is switched over in accordance with the virtual channel information.

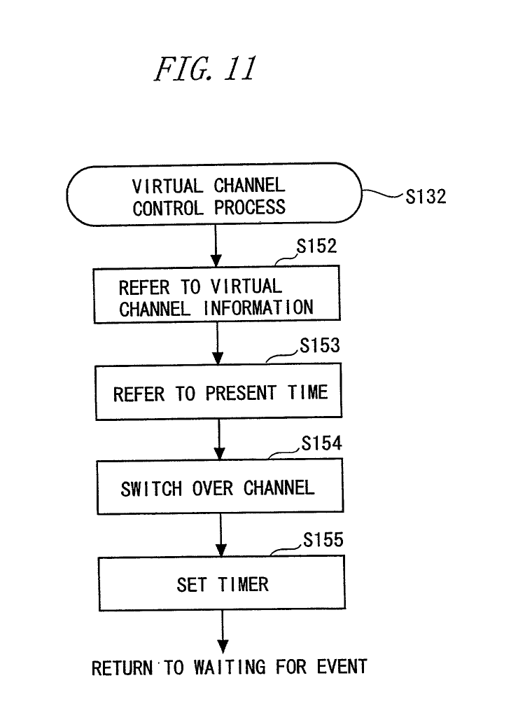

The virtual channel control process will be explained referring to FIG. 11.

To start with, the virtual channel information is ref erred to (S152). Further, the present time is referred to from the OS calendar in the same way as the above (S153).

Next, based on the virtual channel information, the physical channel number corresponding to the time zone containing the present time is set in the virtual channel register 6. The program of the physical channel (broadcast channel) specified by the virtual channel information is thereby demodulated and projected on the TV monitor 8 (S154).

Further, the timer 3 is set so as to generate an event when it is a predetermined time (S155), and there comes the wait-for-event status.

As explained above, the processes in S152 through S155 are started by the timer and are executed based on the virtual channel information stored in the memory 2 in accordance with the time elapse. Accordingly, the user simply specifies the number of 100 or larger as the physical channel number, the broadcast channel based on the virtual channel information is selected and displayed at a proper time on the TV monitor 8 without changing the physical channel.

<Modified Example of Creating virtual Channel Information>

The virtual channel information of the embodiment 1 is created day by day. The embodiment of the present invention is not, however, limited to this, and, for example, the virtual channel information may be created every week and include the specification of broadcasting date.

In the present embodiment 1, when creating the virtual channel information at the center, among the respective programs described in the program information, the programs attached with the captions created by the broadcast company providing the program of each broadcast channel, are set as the recommended programs. There are obtained pieces of information given from a plurality of TV program introducing companies, e.g., electronic TV program guides (EPGs) displayed on web pages on the Internet, and, if the recommended programs are selected according to larger-caption-count in several EPG, the virtual channels containing the more exact recommended programs can be provided.

The program information and the caption information in this embodiment are provided normally from the broadcasting companies of the respective broadcast channels via the broadcast channels and the communication lines such as the Internet etc, however, if difficult to collect such pieces of program information, the program information and the caption information may be manually inputted from TV program columns on the newspaper and magazines at the center.

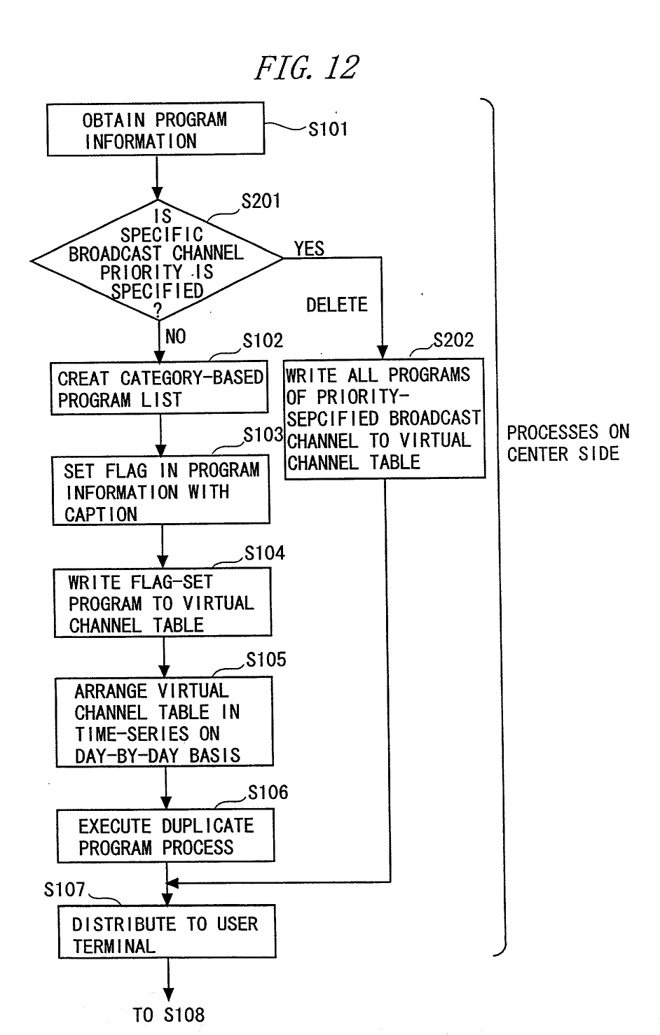

In the present embodiment 1, the programs supplemented with the caption information are selected as the recommended programs from the collected pieces of program information. instead of this, all the programs of the specified broadcast channels may be directly set as the programs of the virtual channels. The procedures of creating the virtual channel information on the center side in this case are shown in a flowchart in FIG. 12.

FIG. 12 shows a modified version of the processes on the center side, which are extracted from within the flowchart in FIG. 8. The same processes as those in FIG. 8 are marked with the same symbols as those in FIG. 8, and their explanations are omitted. Further, the procedures in FIG. 12 are executed as a control program by the CPU 31 of the virtual channel information creating device 30 shown in FIG. 3.

In these procedures, the broadcast channel preferentially selected is specified by use of a mouse 38 and a keyboard 37 shown in FIG. 3 (not shown). The control program executed by the CPU 31 judges whether the priority given to such a specified broadcast channel is specified (S201). If specified so, the program of the specified broadcast channel is selected directly as the virtual channel (S202). Whereas if the priority given to the specified broadcast channel is not specified, the processes subsequent to the process in S102 are executed as in FIG. 8.

The virtual channel information for giving the watching priority to the especially intended broadcasting station can be created on the center side by use of the method described above. Further, for instance, it can be considered that seven different broadcast channels are arranged on the day-by-day basis in the virtual channel information that will be distributed in a week.

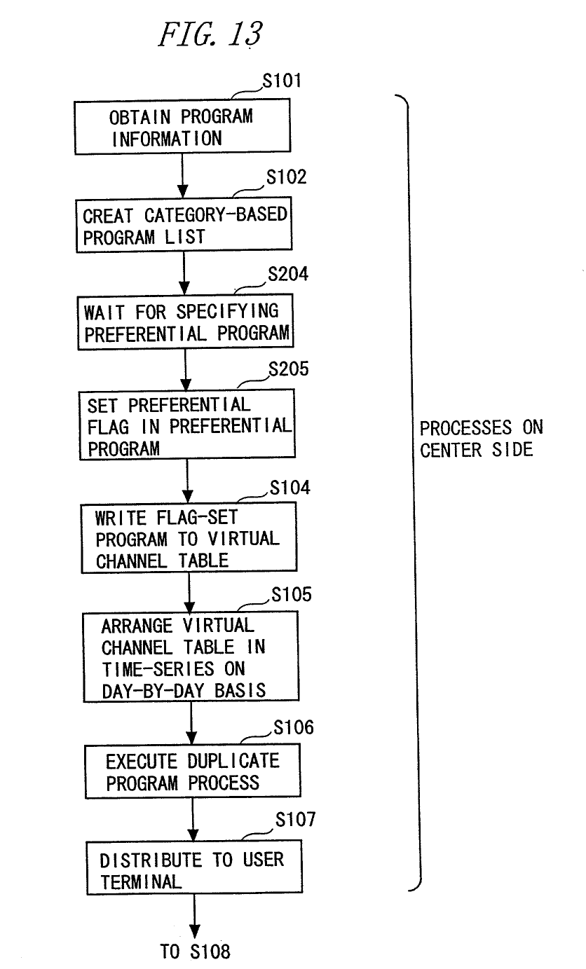

The above-mentioned is what the entire broadcast channels are specified as the virtual channel information, however, there may be provided a means capable of specifying the preferential program that should be individually preferentially selected for every program on the center side. This is that a flag indicating the preferential program is set and stored in the program information per physical channel obtained from each broadcasting company, and the program in which to set the flag indicating this preferential program may be selected when selecting the recommended program. These procedures are shown in a flowchart in FIG. 13.

FIG. 13 shows a modified version of the processes on the center side, which are extracted from within the flowchart in FIG. 8. The same processes as those in FIG. 8 are marked with the same symbols as those in FIG. 8, and their explanations are omitted. Further, the procedures in FIG. 13 are executed as a control program by the CPU 31 of the virtual channel information creating device 30 shown in FIG. 3.

In these procedures, the program individually preferentially selected for every program is specified by the mouse 38 and the keyboard 37 shown in FIG. 3 (S204). Next, the flag is set in the program specified in the process in S204 with respect to the program information obtained in the process in S101 (S205). The program information with the flag set is written to the virtual channel table, thus generating the virtual channel information (S104) . The processes after the process in S104 inclusive are the same as those in FIG. 8.

The virtual channel information for giving the watching priority to the especially intended broadcasting station can be created on the center side by use of the method described above. Namely, the virtual channel information conforming with the intention and the scheme on the center side can be distributed.

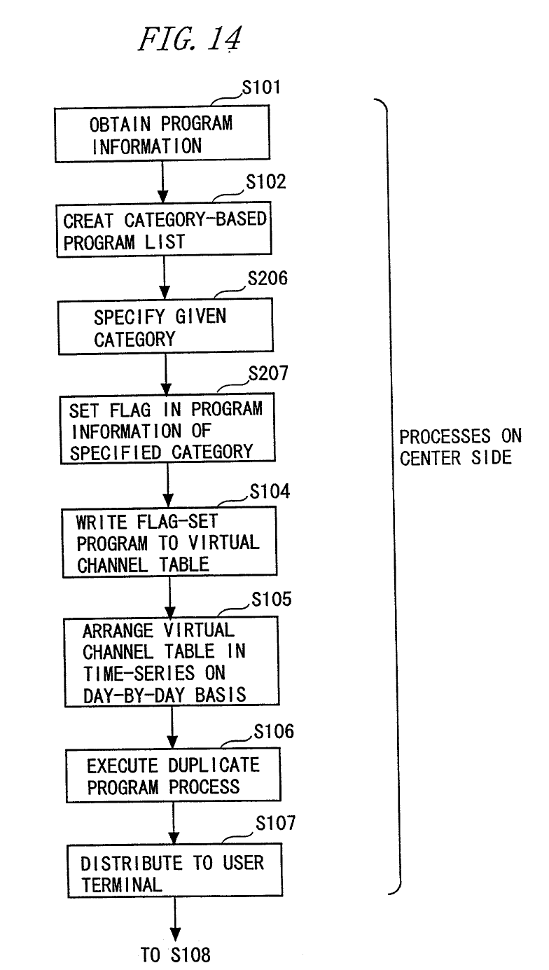

The virtual channel information described above may be created based on categories as types of the programs. Herein, the categories are the types of programs such as a drama, a Japanese movie, news and so on. The procedures of creating the virtual channel information based on these categories are shown in a flowchart in FIG. 14.

FIG. 14 shows, as in the case of FIG. 12, a modified version of the processes on the center side, which are extracted from within the flowchart in FIG. 8. The same processes as those in FIG. 8 are marked with the same symbols as those in FIG. 8, and their explanations are omitted. Further, the procedures in FIG. 14 are executed as a control program by the CPU 31 of the virtual channel information creating device 30 shown in FIG. 3.

In these procedures, a given category is specified by the mouse 38 and the keyboard 37 shown in FIG. 3 (S206). Next, the flag is set in the program corresponding to the category specified in the process in S206 with respect to the program information obtained in the process in S101 (S207). The program information with this flag set is written to the virtual channel table, thus generating the virtual channel information (S104). The processes after the process in S104 inclusive are the same as those in FIG. 8. The virtual channel information is thus created based on the category, whereby it is possible to correspond to the user having a strong directivity to the specified category.

In the embodiment described above, the priority is given to the program depending on the quantity of explanation information with respect to the programs overlapped in time zone. And the priority is given to the program anterior in time zone with respect to the programs overlapped in a part of time zone, and, after the program to be broadcast ahead has completely finished, the channel is switched over to the next. The embodiment of the present invention is not, however, limited to this, and, for example, the program to be selected among the overlapped programs can be determined in any one of the following procedures.

(1) The priority is given to the shorter in broadcasting time among two or more programs with the time zone overlapped. Namely, in the case of broadcasting, in the middle of a program A, a program B that will finish before an end of the program A, it follows that the program is switched over in sequence such as A=>B=>A.

(2) The user is made to select a program that the user does not desire (or desires) to watch. Namely, the virtual channel information is distributed to the respective users while the time zones of the programs remain overlapped, and each user is made to select at such a stage that the user watches. For example, the virtual channel information is displayed in the form of a program list on the TV monitor 8, and there may be taken a procedure such as checking in a do-not-want-to-watch program box (or a want-to-watch program box) by operating the infrared-ray remote controller 11, and so on. In this case, a scheme is that a preferential (non-preferential) flag box is provided in the virtual channel table retaining the virtual channel information in FIG. 5, and the flag can be set corresponding to the above check.

(3) The priority is given to the program added or selected finally when the user edits the virtual channel. Hence, a box for recording a date and time is further prepared for every program contained in the virtual channel information.

In the embodiment 1 described above, at first, the recommended program is selected depending on whether there is the caption information or not. In stead of this, the actually watched history of each user is monitored and accumulated at the center, whereby the virtual channel information containing the exact recommended programs can be created. This can be attained by collecting, because of the center being informed of the change information as shown in S112 in the flowchart in FIG. 8, these reported pieces of information.

Further, as a substitute for the watched history, the watching requests (requests) may be collected from the users. Herein, the watching request contains keywords such as for instance, a name of program, figures appeared, a producer etc and a piece of information specifying a specified category.

Moreover, if the watching information is collected as individual information on every individual user, the virtual channel information for every individual user can be automatically generated.

<Modified Example of Architecture of TV Receiver>

In the embodiment 1 described above, the means for editing the virtual channel involves the use of the infrared-ray remote controller, however, instead of this, there may be used mechanical pointing means such as a mouse, a joystick, a trackball, a push button etc and pointing means such as a pointing device using an electrostatic sensor and a laser, etc.

In the embodiment 1 explained above, the user specifies a given channel number (100 or larger), thereby specifying the receipt using the virtual channel. The infrared-ray RC 11 or the TV monitor 8 may, however, be provided with a toggle switch for switching over a channel mode between a physical channel using mode and a virtual channel using mode without the specified channel allocation described above. Further, menu for selecting a channel mode may be displayed on the screen of TV monitor 8.

Namely, a switching flag corresponding to switching of the toggle switch is provided inside the control program executed by the CPU 1. The control program may judge in accordance with a state of this flag whether the broadcast channel to be received in every time zone should be switched over based on the virtual channel information.

Further, the receipt based on the virtual channel may be displayed on the screen of the TV monitor 8 so that the user can recognize that the broadcast channel is received by automatic switching in a way that specifies the virtual channel.

In the embodiment 1 described above, the selectable channel numbers are displayed on the TV monitor 8 to make the user select it. The channel numbers may be displayed by use of a light emitting diode and a dial type indicator without being limited to the screen itself of the TV monitor 8.

<Modified Example of Program for Creating Virtual Channel Information>

The method of creating the virtual channel information at the center and distributing the created virtual channel information to the STB 10 of the user, has been explained in this embodiment. This method is executed by the computer program of the computer provided normally at the center. Accordingly, the computer at the center functions as the virtual channel information creating device including the program information collection module, the recommended program selection module and the virtual channel information generation module.

This computer program may also be executed by the CPU 1 provided in the STB 10 of each user. That is, the STB 10 may create the virtual channel information by collecting the program information and the caption information. In this case, the STB 10 functions as the virtual channel information creating device including the program information collection module, the recommended program selection module and the virtual channel information generation module, and there is not required the process of distributing the virtual channel information to the STB 10 of the user from the center.

This computer program can be recorded on a readable-by-computer recording medium such as a floppy disk, magneto-optic disk, a CD-ROM, a CD-R/W, an MO, a DVD, a DAT, an 8 mm tape, a memory card ROM etc. Further, this computer program can be stored in a hard disk and a memory of the computer, and can be distributed to other computers via a communication line. As a result, the computer receiving the distribution of this computer program can be made to function as the virtual channel information creating device.

<Computer program for controlling virtual channel>

The computer program executed on the CPU 1 to control virtual channel may be recorded on a readable-by-computer recording medium. The computer program can be read out and executed on a computer including TV demodulator 7. Then the present invention may be embodied. Further, this program can be stored in a hard disk and a memory of the computer, and can be distributed to other computers via a communication line.

### Embodiment 2

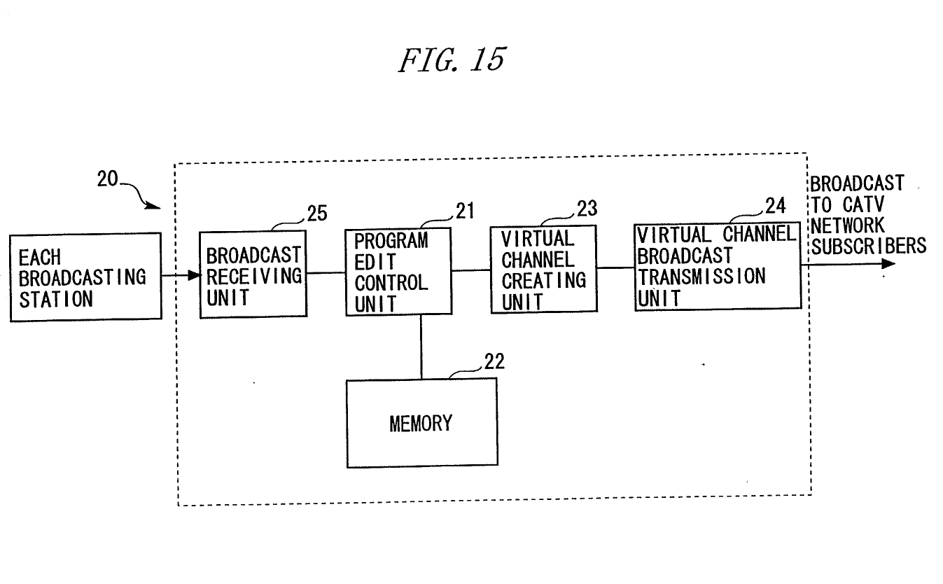

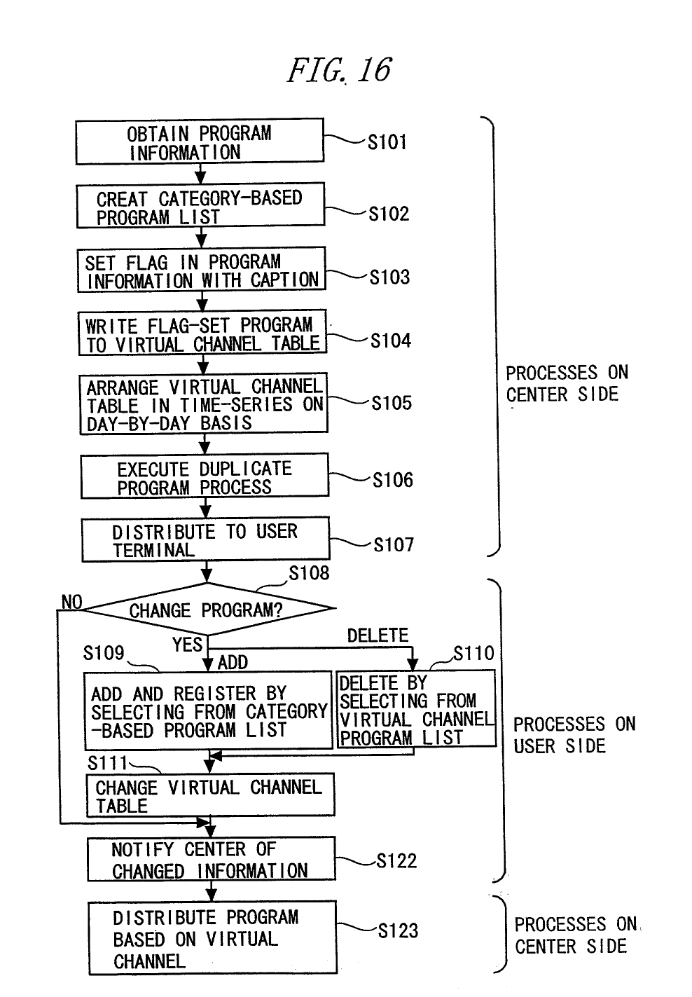

An embodiment 2 of the present invention will be explained referring to FIGS. 15 and 16. FIG. 15 is a block diagram showing an architecture of a broadcasting system in this embodiment. In the embodiment 1, there has been explained the TV receiver schemed to make each user see as if providing the broadcast of the virtual channel under the control of the STB 10 possessed by each user. The broadcasting system in this embodiment provides one or more broadcast channels as virtual channels in addition to the normal broadcast channels at the center as the transmission side of CATV.

As shown in FIG. 15, this broadcasting system 20 includes a program edit control unit (CPU) for creating the virtual channel information and controlling the whole broadcasting system, a memory 22 for storing the control program executed by the program edit control unit 21 and the data used in the program edit control unit 21, a broadcast receiving unit 25 for receiving the programs distributed from the respective broadcasting stations and the data related to the programs, a virtual channel creating unit 23 for synthesizing the received programs in accordance with the virtual channel information, and a virtual channel broadcast transmission unit 24 for transmitting and receiving the synthesized program and the virtual channel information via a CATV network.

The program edit control unit 21 executes the control program stored in the memory 22, thereby creating the virtual channel information, distributing the created virtual channel information to the users (the STBs 10 of the respective users), receiving change information from the user terminal, synthesizing the programs as virtual channels based on the virtual channel information created (or changed by users), and distributing the synthesized program to the STB 10 of each user.

Broadcasting procedures of the virtual channel broadcasting between the user and the broadcast system 20 including this program edit control unit 21, will be explained in conjunction with a flowchart in FIG. 16. Processes in S101 through S111 in the flowchart in FIG. 16 are the same as those in FIG. 8 and therefore marked with the same symbols, and their explanations are omitted. Accordingly, the virtual channel information created at the center is, as in the case of FIG. 8, temporarily distributed to each user (S107) and changed by each user (S108 through S111).

In FIG. 16, in a process in S122, this changed item of virtual channel information is transmitted back to the center. Based on the virtual channel information transmitted back, the virtual channel creating unit 23 of the broadcast system 20 at the center synthesizes the programs provided from the respective broadcasting stations, ad the synthesized program is broadcast from the virtual channel broadcast transmission unit 24 (S123).

In this embodiment, channels having CATV channel numbers of 200 or larger are used as the virtual channels. Hence, the channel numbers up to 199 are used for the channels of each of the broadcasting stations, however, the channel numbers of 200 or larger are provided as the virtual channels through which the programs of the respective broadcasting stations exist in mixture in a way that delimits their time zones.

### Modified Example

In the above, there has been explained the broadcast system in which the channel numbers of 200 or larger are allocated to the virtual channels, and the programs from the respective broadcasting stations are synthesized and broadcast. These virtual channels may be, when provided, individually distributed to every user without through broadcasting. Namely, the virtual channel information shown in FIGS. 4 or 5 may be created for the individual user establishing a specified contract and may be broadcast by ensuring the broadcast channel for every such user.

Moreover, a program of the virtual channel information including programs other than the programs broadcast at the normal CATV broadcast channels, e.g., a movie and the news already broadcast in the past may also be created based on the watched history of every user as in that case. For example, the user's directivity can be presumed from the watched history on the basis of the virtual channel information sent back from the user. Further, the news not watched can be redistributed. Thus, the program can be distributed in response to the request of the individual user.

The method of actualizing the CATV broadcast channels as the virtual channels has been explained in this embodiment, however, the embodiment of the present invention is not limited to the types of the broadcasting media. The present invention can be carried out also in, e.g., the satellite broadcast and in the TV broadcast through on the normal ground waves.

### INDUSTIRIAL APPLICABILITY

The present invention is applicable to manufacturing the TV receiver that relieves a user's labor to switchover the channel by searching for the program when the user receives the TV program. The present invention is also applicable to the TV broadcast for distributing the program to this TV receiver.

What is claimed is:

1. A television receiver comprising:
a receiving unit receiving a television broadcast by selecting a specified broadcast channel from a plurality of broadcast channels;
a control unit controlling said receiving unit in order to receive the television broadcast of the specified broadcast channel;
a channel information unit receiving virtual channel information containing information for specifying a time zone and information related to the broadcast channel that should be selected in this time zone;
a storing unit storing the virtual channel information; and
a timer notifying said control unit of a time,
wherein said control unit controls said receiving unit to switch over the broadcast channel received in every time zone in accordance with the virtual channel information upon the notification from the timer.

2. A television receiver according to claim 1, further comprising number specifying unit specifying the broadcast channel to be received with a number,
wherein said control unit allocates a specified number to the virtual channel received based on the virtual channel information, controls said receiving unit to switch over the broadcast channel received in every time zone in accordance with the virtual channel information when the number allocated to the virtual channel is specified, and controls said receiving unit, if a number other than the number allocated to the virtual channel is specified, so as to be fixed to a broadcast channel of this number.

3. A television receiver according to claim 1, further comprising editor unit for editing the virtual channel information.

4. A television receiver comprising:
displaying unit displaying at least one virtual channel together with a plurality of broadcast channels to a user; and
a virtual channel control unit making the user receive a program reserved by the user among the plurality of broadcast channels when the virtual channel is specified.

5. A television program distribution system distributing programs through a plurality of broadcast channels, comprising:
a selecting unit selecting a recommended program recommended to receive;
a generating unit generating virtual channel information containing a time zone of broadcasting this recommended program and a broadcast channel for broadcasting this recommended program;
a providing unit providing the virtual channel information to a watching terminal; and
a switching unit automatically switching over the broadcast channel received by said watching terminal on the basis of the virtual cannel information.

6. A virtual channel information creating method of creating virtual channel information as a virtual channel into which a plurality of broadcast channels are combined, comprising:
collecting program information containing at least information for specifying a time zone and information related to a program broadcast in this time zone with respect to the plurality of broadcast channels;
selecting a specified recommended program from the collected pieces of program information; and
generating virtual channel information containing information for specifying a time zone in which the recommended program is broadcast and information related to the broadcast channel that should be selected in this time zone.

7. A virtual channel information creating method according to claim 6, wherein all the programs broadcast at the specified broadcast channel are selected as the recommended programs.

8. A virtual channel information creating method according to claim 6, wherein the recommended program is selected based on a category as a type of the program.

9. A virtual channel information creating method according to claim 6, wherein the recommended program is selected based on whether supplementary information exists in the collected program information or based on based on a change of contents of the supplementary information.

10. A virtual channel information creating method according to claim 6, wherein the recommended program is selected based on a length of a broadcasting time.

11. A virtual channel information creating method according to claim 6, further comprising collecting watching requests of viewers or watched history thereof,
wherein the recommended program is selected based on the watching requests or the watched history.

12. A virtual channel information creating method according to claim 6, further comprising specifying a preferential program that should be preferentially selected as a recommended program,
wherein the recommended programs are selected in a way that gives the priority to this preferential program.

13. A virtual channel information creating system for creating virtual channel information as a virtual channel into which a plurality of broadcast channels are combined, comprising:
a program information collecting module collecting program information containing at least information for specifying a time zone and information related to a program broadcast in this time zone with respect to the plurality of broadcast channels;
a recommended program selection module selecting a specified recommended program from the collected pieces of program information; and
a virtual channel information generating module generating virtual channel information containing information for specifying a time zone in which the recommended program is broadcast and information related to the broadcast channel that should be selected in this time zone.

14. A readable-by-computer recording medium recorded with a virtual channel information creating program for creating virtual channel information as a virtual channel into which a plurality of broadcast channels are combined, said program comprising:
collecting program information containing at least information for specifying a time zone and information related to a program broadcast in this time zone with respect to the plurality of broadcast channels;
selecting a specified recommended program from the collected pieces of program information; and
generating virtual channel information containing information for specifying a time zone in which the recommended program is broadcast and information related to the broadcast channel that should be selected in this time zone.

15. A readable-by-computer recording medium recorded with a control program executed by a computer which is connected to
a receiving unit receiving a television broadcast by selecting a specified broadcast channel from a plurality of broadcast channels,
and channel information unit receiving virtual channel information containing information for specifying a time zone and information related to the broadcast channel that should be selected in this time zone,
said control program comprising:
referring the virtual channel information when notified of a time; and
controlling the receiving unit in order to receive the television broadcast of the specified broadcast channel, involving when notified of a time controlling the receiving unit to switch over the broadcast channel that should be received in every predetermined time zone in accordance with the virtual channel information.
